(19) United States
(12) Patent Application Publication
(10) Pub. No.: US 2016/0090034 A1
(43) Pub. Date: Mar. 31, 2016

(54) Illuminated Emergency Warning Device

(71) Applicant: Donald Brown, BALTIMORE, MD (US)

(72) Inventor: Donald Brown, BALTIMORE, MD (US)

(21) Appl. No.: 14/863,970

(22) Filed: Sep. 24, 2015

Related U.S. Application Data
(60) Provisional application No. 62/055,139, filed on Sep. 25, 2014.

(51) Int. Cl. B60Q 7/00; F21V 21/32; F21V 21/096

(52) U.S. Cl. CPC B60Q 7/00; F21V 21/096; F21V 21/32; F21Y 2101/02

(57) ABSTRACT

An illuminated emergency warning device for warning drivers to merge into the next lane due to a disabled vehicle. The emergency warning device includes a rectangular housing having a front wall and a rear wall. A first light assembly is disposed on the front wall of the housing and a second light assembly is disposed on the rear wall of the housing, wherein each light assembly is arranged in an arrow shape thereon. The arrow shape indicates to other drivers which direction to proceed in order to avoid the disabled vehicle. The present invention further comprises a flexible support secured to the housing and a mount, wherein the mount allows the device to be removably attached to the exterior of a vehicle. The emergency warning device further includes a power source and a control each electrically connected to the light assemblies for powering and controlling the device.

### CROSS REFERENCE TO RELATED APPLICATION

This application claims the benefit of U.S. Provisional Application No. 62/055,139 filed on Sep. 25, 2014. The above identified patent application is herein incorporated by reference in its entirety to provide continuity of disclosure.

### BACKGROUND OF THE INVENTION

### Field of the Invention

The present invention relates to illuminated signs. More specifically, the present invention provides an illuminated emergency warning device comprising a housing having light assemblies disposed on a front side and rear side of the housing, wherein the light assemblies are adapted to emit light outwards therefrom in order to warn oncoming traffic of a disabled vehicle.

Disabled vehicles on the side of the road can be very dangerous if passing motorists do not realize that the vehicle is present, putting both the passing motorist and any individuals in or around the disabled vehicle at risk of injury. Many drivers experience a need to immediately change a tire, check their vehicle's engine, or perform other repairs or maintenance to a vehicle, wherein the individual may have no choice but to pull off to the side of the road. Conventionally, individuals attempt to mitigate this risk by turning on their hazard lights. However, hazard lights do not provide adequate warning to passing motorists from far away because the lights are not strong enough or distinctive enough. Therefore, passing motorists may not have enough time to properly react to the disabled vehicle on the shoulder of the road by safely changing lanes. Therefore, there is a need in the prior art for a device that is adapted to provide adequate long-distance warning to passing motorists as to the presence of a disabled vehicle on the shoulder of the road.

Devices have been disclosed in the prior art that relate to illuminated signs. These include devices that have been patented and published in patent application publications. These devices generally relate to lights in the shape of an arrow, such as U.S. Pat. No. 7,388,514, U.S. Pat. No. 5,103,205, U.S. Patent Application Publication Number 2012/0056757, U.S. Patent Application Publication Number 2006/0162643, and U.S. Pat. No. 6,138,394.

These prior art devices have several known drawbacks. These device provide an illuminated arrow within a housing, however, fail to provide a flexible support for mounting and positioning the illuminated arrow in various positions on various surfaces of a vehicle.

In light of the devices disclosed in the prior art, it is submitted that the present invention substantially diverges in design elements from the prior art and consequently it is clear that there is a need in the art for an improvement to existing illuminated signs. In this regard the instant invention substantially fulfills these needs.

### SUMMARY OF THE INVENTION

In view of the foregoing disadvantages inherent in the known types of illuminated emergency warning devices now present in the prior art, the present invention provides a new illuminated emergency warning device wherein the same can be utilized for providing convenience for the user when warning drivers to merge into the next lane due to a disabled vehicle.

It is therefore an object of the present invention to provide a new and improved illuminated emergency warning device that has all of the advantages of the prior art and none of the disadvantages.

It is another object of the present invention to provide an illuminated emergency warning device comprising a housing having one or more light assemblies disposed on a front wall and a rear wall thereof.

Another object of the present invention is to provide an illuminated emergency warning device wherein each light assembly is configured to emit light outward therefrom in order to warn drivers to merge into the next lane due to a disabled vehicle.

Yet another object of the present invention is to provide an illuminated emergency warning device comprising a power source and a control electronically connected to the light assemblies in order to operate the device.

Yet another object of the present invention is to provide an illuminated emergency warning device comprising a flexible support having a first end and a second end, wherein the first end is secured to the housing and the second end is secured to a mount adapted to secure the device to a vehicle.

Another object of the present invention is to provide an illuminated emergency warning device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the illuminated emergency warning device.

FIG. 2 shows a perspective view of an embodiment of the illuminated emergency warning device in use.

### DETAILED DESCRIPTION OF THE INVENTION

Reference is made herein to the attached drawings. Like reference numerals are used throughout the drawings to depict like or similar elements of the illuminated emergency warning device. For the purposes of presenting a brief and clear description of the present invention, the preferred embodiment will be discussed as used for alerting drivers to the presence of a disabled vehicle. The figures are intended for representative purposes only and should not be considered to be limiting in any respect.

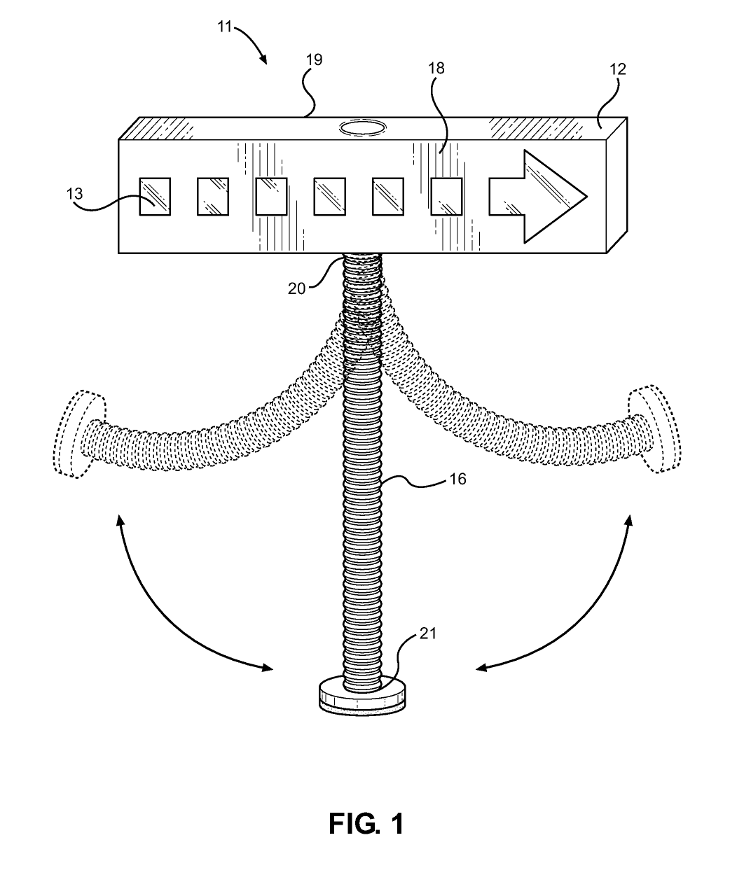

Referring now to FIG. 1, there is shown a perspective view of an embodiment of the illuminated emergency warning device. The illuminated emergency warning device 11 comprises a housing 12 having a front wall 18 and a rear wall 19 opposite said front wall 18. Preferably, the housing 12 is rectangular in shape, however, in alternate embodiments the housing 12 can be any suitable shape, such as square or irregular.

The housing 12 comprises one or more light assemblies 13, wherein each light assembly 13 is adapted to illuminate and emit light outwards therefrom. The light assemblies 13 comprise one or more light sources, such as light emitting diodes (LED). The light assemblies 13 are preferably arranged in the shape of an arrow so as to warn and direct drivers to merge into the next lane in which the arrow shaped light assembly 13 is pointing. In other embodiments, the light assembly 13 can be shaped in any suitable configuration so as to warn a driver of a disabled vehicle in which the light assembly 13 is attached, such as indicia stating “merge right” or “merge left.” In some embodiments, the light assemblies 13 are adapted to flash in order to improve the visibility thereof.

In the illustrated embodiment, a first light assembly 13 is disposed on the front wall 18 of the housing 12 and a second light assembly 13 is disposed on the rear wall 19 of the housing 12. The second light assembly 13 is not shown in FIG. 1, however, it is a mirror image of the first light assembly 13. Thus, the housing 12 is adapted to be rotated 180 degrees so the second light assembly 13 will point in the opposite direction of the first light assembly 13 as originally positioned. In this way, the device 11 is adapted to be positioned on either side of a vehicle to indicate to a motorist to merge to the left or to the right, as the arrow indicates. Further, the light assemblies 13 are adapted to warn passing motorists traveling in either approaching direction. In some embodiments, the light assemblies 13 on the opposing sides of the housing 12 are illuminated with light sources of different colors in order to differentiate them to opposing motorists. Preferably, the housing 12 is weatherproof, thereby preventing the light assemblies and operating components disposed within the housing 12 from becoming damaged by the rain, sun, and the like.

The illuminated emergency warning device 11 comprises a power supply electrically connected to the light assemblies in order to supply power thereto. Any suitable power source can be used, such as a battery, a connection that is adapted to be plugged into a vehicle's power outlet, or another such power source. In some embodiments, the emergency warning device 11 comprises both a rechargeable battery and a connection for a vehicle's power outlet, thereby allowing the battery to be recharged when not in use. The illuminated emergency warning device 11 further comprises a control electronically connected to the light assemblies so as to permit the light assemblies to be turned on and off. Any suitable control can be used, such as a switch disposed on the surface of the housing 12.

The illuminated emergency warning device 11 further comprises a flexible support 16 having a first end 20 and a second end 21. The first end 20 is secured to the lower end of the housing 12 by any suitable means, such as screws or a ball and socket connection. The flexible support 16 permits the housing 12 to remain in a substantially horizontal position on the first end 20 thereof. In the illustrated embodiment, the flexible support 16 comprises an elongated tubing adapted to allow the second end 21 thereof to bend and rotate in order for the device 11 to be removably secured to a horizontal or vertical support surface. The flexible support 16 is composed of any semi-rigid material that is adapted to allow the support 16 the bend and retain the position in which it is disposed.

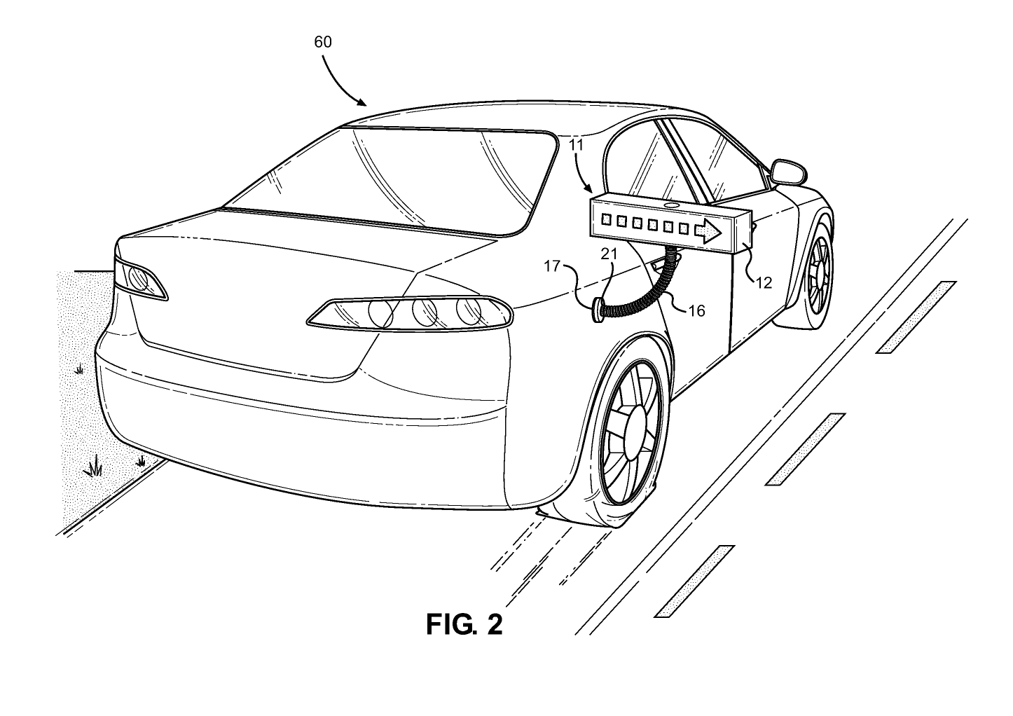

Referring now to FIG. 2, there is shown a perspective view of an embodiment of the illuminated emergency warning device in use. The second end 21 is secured to a mount 17, wherein the mount 17 is adapted to be removably secured to a vehicle 60. In the illustrated embodiment, the mount 17 is magnetic so as to allow the device 11 to secure to a metallic portion of the vehicle 60. In other embodiments, any suitable mount 17 can be used, such as a clip adapted to fit over a vehicle window.

In operation, the mount 17 of the illuminated emergency warning device 11 is removably secured to an exterior portion of a vehicle 60, preferably at the rear thereof. The flexible support 16 is bent and rotated as needed such that the housing 12 is positioned horizontally thereon. Thus, the flexible support 16 permits the device 11 to extend outward from any side of a vehicle 60 rather than having to be positioned on top of the vehicle 60. The control switch is turned to the on position in order to illuminate the light assemblies disposed on the front and rear walls of the housing 12. As other drivers approach the user's vehicle, the driver will be sufficiently warned of the presence of a disabled vehicle and the need to merge into the next lane as indicated by the arrow shape of the light assemblies.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An illuminated emergency warning device, comprising:
a housing having a front wall and a rear wall;
one or more light assemblies disposed on said housing, wherein each of said one or more light assemblies is configured to emit light outward therefrom;
a light source disposed in said one or more light assemblies;
a flexible support comprising an elongated tubing having a first end and a second end, wherein said first end is secured to said housing;
a mount secured to said second end of said flexible support, wherein said mount is configured to removably secure said housing to a vehicle.

2. The illuminated emergency warning device of claim 1, further comprising a control electronically connected to said one or more light assemblies so as to permit said one or more light assemblies to be turned on and off.

3. The illuminated emergency warning device of claim 1, wherein said one or more light assemblies comprise a first light assembly disposed on said front wall of said housing and a second light assembly disposed on said rear wall of said housing.

4. The illuminated emergency warning device of claim 1, wherein said one or more light assemblies are in a shape of an arrow.

5. The illuminated emergency warning device of claim 1, wherein said mount is magnetic.

6. The illuminated emergency warning device of claim 1, wherein said flexible support is composed of a semi rigid material.

7. The illuminated emergency warning device of claim 1, wherein said flexible support is adapted to be bent into a desired configuration and is able to retain that configuration.

8. The illuminated emergency warning device of claim 1, further comprising a power supply electrically connected to said one or more light assemblies.
